(19) United States
(12) Patent Application Publication
(10) Pub. No.: US 2026/0128356 A1
(43) Pub. Date: May 7, 2026

(54) Battery Cell with Constant Compression Force

(71) Applicant: GM GLOBAL TECHNOLOGY OPERATIONS LLC, DETROIT, MI (US)

(72) Inventors: Shashank RAMESH, Warren, MI (US); Chinmaya PATIL, South Lyon, MI (US); Madhusudan RAGHAVAN, West Bloomfield, MI (US); Derek Frei LAHR, Ann Arbor, MI (US); Jun-mo KANG, Ann Arbor, MI (US); Insu CHANG, Troy, MI (US)

(21) Appl. No.: 18/939,745

(22) Filed: Nov. 7, 2024

(51) Int. Cl. H01M 10/04; H01M 50/209; H01M 50/211; H01M 50/242; H01M 50/249; H01M 50/289

(52) U.S. Cl. CPC H01M 10/0468; H01M 50/242; H01M 50/249; H01M 50/289; H01M 50/209; H01M 50/211

(57) ABSTRACT

Aspects of the disclosure include battery cells with constant compression force mechanisms. An exemplary vehicle includes an electric motor and a battery pack electrically coupled to the electric motor. The battery pack includes a plurality of battery cells and a constant force mechanism (CFM) coupled to a battery cell. The CFM includes a first vertical spring, a second vertical spring, a horizontal spring, and a plurality of rigid links. A centerline-to-centerline distance between the first vertical spring and the second vertical spring is equal to a free length of the horizontal spring. A first spring constant of the first vertical spring and a second spring constant of the second vertical spring are the same, and the first spring constant and the second spring constant are each half a third spring constant of the horizontal spring.

### INTRODUCTION

The present disclosure relates to battery cell manufacturing, and particularly to a battery cell, module, or pack with a constant compression force mechanism.

Lithium-ion batteries, also known as lithium-ion cells, are a type of rechargeable battery technology that have gained significant attention due to their relatively high energy density and long cycle life compared to other battery chemistries. The anode (negative electrode) in a lithium-ion cell is typically made of graphite, a carbon-based material that can reversibly intercalate and deintercalate lithium ions. The cathode (positive electrode) can be made of various lithium-containing compounds, such as lithium transition metal oxides (e.g., LiCoO₂, LiNiMnCoO₂, etc.), lithium metal phosphates (e.g., LiFePO₄), or other suitable materials that can reversibly intercalate and deintercalate lithium ions.

The electrodes in a lithium-ion cell are separated by an electrolyte, which is typically a lithium salt dissolved in an organic solvent, a solid polymer or solid-state electrolyte. The electrolyte acts as a medium for lithium ion transport between the anode and cathode during charge and discharge processes. Current collectors provide a conductive pathway for electrons to flow between the electrodes and an external circuit. The current collector for the anode is typically made of copper or a copper alloy, while the current collector for the cathode is typically made of aluminum or an aluminum alloy. During the discharge process, lithium ions deintercalate from the anode and migrate through the electrolyte to intercalate into the cathode material, while electrons flow through the external circuit to power a device. During charging, this process is reversed, with lithium ions being extracted from the cathode and intercalated back into the anode.

### SUMMARY

In one exemplary embodiment a vehicle includes an electric motor and a battery pack electrically coupled to the electric motor. The battery pack includes a plurality of battery cells and a constant force mechanism (CFM) coupled to a battery cell of the plurality of battery cells. The CFM includes a first vertical spring, a second vertical spring, a horizontal spring, and a plurality of rigid links. A centerline-to-centerline distance between the first vertical spring and the second vertical spring is equal to a free length of the horizontal spring. A first spring constant of the first vertical spring and a second spring constant of the second vertical spring are the same, and the first spring constant and the second spring constant are each half a third spring constant of the horizontal spring.

In addition to one or more of the features described herein, in some embodiments, the plurality of rigid links includes a first rigid link coupled to a first end of the first vertical spring and a first end of the horizontal spring and a second rigid link coupled to a first end of the second vertical spring and a second end of the horizontal spring.

In some embodiments, the plurality of rigid links includes a third rigid link coupled to a second end of the first vertical spring and the first end of the horizontal spring and a fourth rigid link coupled to a second end of the second vertical spring and the second end of the horizontal spring.

In some embodiments, a contact plate is in direct contact with a first battery cell of the plurality of battery cells.

In some embodiments, the first end of the first vertical spring and the first end of the second vertical spring are coupled to the contact plate.

In some embodiments, the CFM includes a base plate.

In some embodiments, the second end of the first vertical spring and the second end of the second vertical spring are coupled to the base plate.

In some embodiments, the plurality of rigid links includes a third rigid link coupled to the first end of the horizontal spring and a fourth rigid link coupled to the second end of the horizontal spring.

In some embodiments, a contact plate is in direct contact with a first battery cell of the plurality of battery cells and a base plate is coupled to the third rigid link and the fourth rigid link.

In some embodiments, the cfm includes a force adjusting plate.

In some embodiments, a second end of the first vertical spring and a second end of the second vertical spring are coupled to the force adjusting plate.

In some embodiments, an actuator is coupled to the force adjusting plate. The actuator is configured to change a distance between the force adjusting plate and the first battery cell.

In some embodiments, a controller is coupled to the actuator. The controller is configured to direct the actuator to change the distance between the force adjusting plate and the first battery cell to adjust an amount of force applied against the first battery cell.

In another exemplary embodiment a system includes a battery pack having a plurality of battery cells and a constant force mechanism coupled to at least one battery cell of the plurality of battery cells. The constant force mechanism includes a first vertical spring, a second vertical spring, a horizontal spring, and a plurality of rigid links. A centerline-to-centerline distance between the first vertical spring and the second vertical spring is equal to a free length of the horizontal spring, the free length being a length of the horizontal spring when free of an external load. A first spring constant of the first vertical spring and a second spring constant of the second vertical spring are the same, and the first spring constant and the second spring constant are each half a third spring constant of the horizontal spring.

In some embodiments, a piston is coupled to the constant force mechanism. In some embodiments, a ribbon is positioned adjacent to the at least one battery cell. In some embodiments, displacing the piston adjusts a volume of fluid in the ribbon.

In some embodiments, the system includes a force adjusting plate and an actuator coupled to the force adjusting plate. The actuator is configured to change a distance between the force adjusting plate and the piston.

In some embodiments, the system includes a pressure sensor and a controller coupled to the actuator. The controller is configured to direct the actuator to change the distance between the force adjusting plate and the piston responsive to a measurement of the pressure sensor.

In some embodiments, the system includes a battery cell tray coupled to each battery cell of the plurality of battery cells. The battery cell tray is configured to prevent cell-to-cell relative motion between the battery cells of the plurality of battery cells.

In yet another exemplary embodiment a method can include providing a battery pack having a plurality of battery cells and coupling a constant force mechanism to at least one battery cell of the plurality of battery cells. The constant force mechanism includes a first vertical spring, a second vertical spring, a horizontal spring, and a plurality of rigid links. A centerline-to-centerline distance between the first vertical spring and the second vertical spring is equal to a free length of the horizontal spring. In some embodiments, a first spring constant of the first vertical spring and a second spring constant of the second vertical spring are the same, and the first spring constant and the second spring constant are each half a third spring constant of the horizontal spring.

In some embodiments, the method includes forming a piston coupled to the constant force mechanism and forming a ribbon positioned adjacent to the at least one battery cell. In some embodiments, displacing the piston adjusts a volume of fluid in the ribbon.

In some embodiments, the method includes forming a force adjusting plate and coupling an actuator to the force adjusting plate. The actuator is configured to change a distance between the force adjusting plate and the piston.

In some embodiments, the method includes providing a pressure sensor to monitor a pressure of the fluid and coupling a controller to the actuator. The controller is configured to direct the actuator to change the distance between the force adjusting plate and the piston responsive to a measurement of the pressure sensor.

In some embodiments, the method includes forming a battery cell tray coupled to each battery cell of the plurality of battery cells. The battery cell tray is configured to prevent cell-to-cell relative motion between the battery cells of the plurality of battery cells.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2 is an example battery cell in accordance with one or more embodiments;

FIG. 3A is a constant force mechanism in accordance with one or more embodiments;

FIG. 3B is a detailed view of the constant force mechanism of FIG. 3A in accordance with one or more embodiments;

FIG. 4 is a detailed view of an alternative embodiment of the constant force mechanism of FIG. 3A in accordance with one or more embodiments;

FIG. 5 is a control system for a constant force mechanism in accordance with one or more embodiments;

FIG. 6 shows cell pressure release and cell pressure increase using a constant force mechanism in accordance with one or more embodiments;

FIG. 7A is a constant force mechanism using pressurized fluid in accordance with one or more embodiments;

FIG. 7B is a detailed view of the constant force mechanism of FIG. 7A in accordance with one or more embodiments;

FIG. 8 is an alternative embodiment of a constant force mechanism using pressurized fluid in accordance with one or more embodiments;

FIG. 9. is a computer system according to one or more embodiments; and

FIG. 10 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Electrochemical cells, such as prismatic cans and pouch cells, exhibit expansion and contraction during charge and discharge cycles, respectively. Over time, these cells can also undergo irreversible expansion as they age, primarily due to chemical and structural changes within the cell. Irreversible cell expansion leads to an increase in the cell's physical dimensions over time.

The battery packs and modules which house these electrochemically cells are often constant stiffness (fixed) structures. Unfortunately, as a cell expands (both irreversibly due to aging factors and reversibly while charging), a fixed structure cannot accommodate the increased volume without exerting additional pressure on the cell. Over time, this increase in cell pressure can accelerate cell aging, increase internal resistance, and reduce overall cell performance and lifespan.

This disclosure introduces various constant compression force mechanisms for battery cells, modules, and packs. Specifically, described herein are various constant compression force mechanisms (also referred to as constant force mechanisms, or CFMs) that provide a solution to the problem of maintaining a constant compression force and/or pressure on battery cells as those cells reversibly and irreversibly expand and reversibly contract during their lifecycle. In some embodiments, a battery back or module includes one of more CFMs, each designed to generate and maintain constant compression force/pressure against one or more battery cells as the cells expand and contract with cycling over their respective lifetimes. In other words, each CFM is capable of a range of motion that absorbs or otherwise accommodates reversible and irreversible thickness changes in a battery cell.

In some embodiments, each CFM unit consists of two springs oriented in a first direction and a spring oriented in a second direction orthogonal to the first direction, linked together using rigid links. For convenience, the two springs oriented in the first direction are referred to herein as “vertical springs” and the spring oriented orthogonal to the first direction is referred to herein as a “horizontal spring”, although it should be understood that the first and second directions themselves depend on the physical orientation of the respective CFM unit. The vertical springs connect the base plate to a contact plate which applies constant pressure to the battery cell (pouch, prismatic can, etc.). In some embodiments, each CFM unit is designed such that (1) a distance between the vertical springs is equal to the free length of the horizontal spring and (2) a spring constant (stiffness) of each vertical spring is half that of the horizontal spring. This results in a constant force being applied by the CFM(s) to the battery cell regardless of the size (thickness) of the battery cell.

In some embodiments, each CFM unit is coupled to a piston to direct pressurized fluid into a pressurized ribbon placed against the battery cell. In this configuration, assembly is somewhat simplified as the need for cell compression at the module/pack level is eliminated. Moreover, the pressurized ribbon can provide a cooling function as well as cell pressurization via the inclusion of thermal barriers and cooling channels. In addition, pressure can be reduced during thermal events by leveraging the pressurized ribbons to increase thermal resistance between cells, minimizing boiling.

The CFMs described herein offer a number of advantages over prior battery cell systems. In particular, and without wishing to be bound by theory, it has been found that applying a high initial compression force to a battery cell can help in preventing delamination, while utilizing low stiffness structures that maintain consistent compression force against a battery cell as the cell thickness changes can positively impact aging and performance. Other advantages are possible. For example, in some embodiments, one or more CFM units include a force adjusting plate that allows for real-time adjustments to the applied compressive force of the respective CFM(s) during operation. The force adjusting plate can be repositioned to bias (positively or negatively) the pressure applied against a battery cell. In some embodiments, the force adjusting plate is coupled to an actuator and controller, allowing the overall assembly to make real-time fine-tuning adjustments to the compression forces experienced by a battery cell.

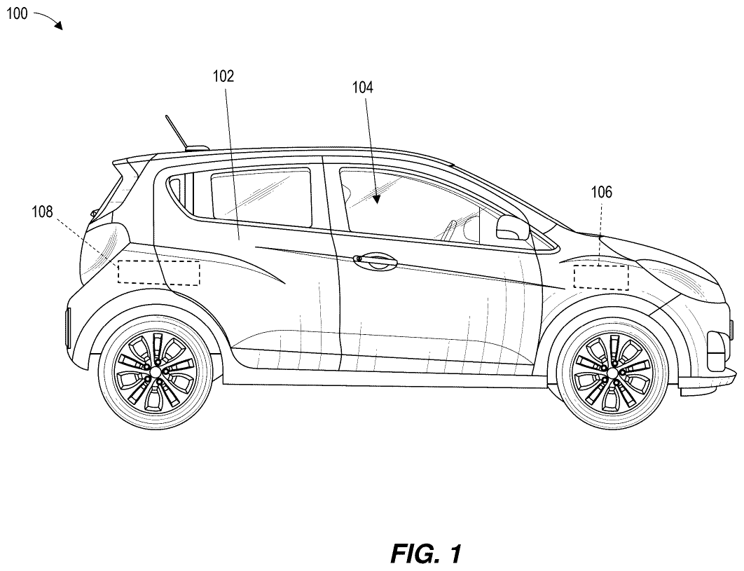

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

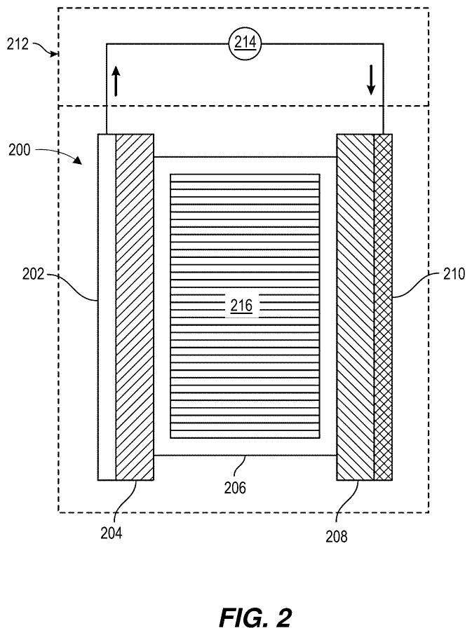

FIG. 2 illustrates an example battery cell 200 in accordance with one or more embodiments. The battery cell 200 can be incorporated as one of a number of battery cells in a battery pack (e.g., the battery pack 108 in FIG. 1). As shown in FIG. 2, the battery cell 200 includes an anode current collector 202, an anode active material layer 204, a separator 206, a cathode active material layer 208, and a cathode current collector 210, configured and arranged as shown.

The anode current collector 202 and the cathode current collector 210 respectively collect and move free electrons to and from an external circuit 212. In some embodiments, external circuit 212 includes a load device 214 (e.g., the electric motor 106 in FIG. 1). In some embodiments, external circuit 212 and load device 214 connect the anode active material layer 204 (through the anode current collector 202, also referred to as the negative electrode) and the cathode active material layer 208 (through the cathode current collector 210, also referred to as the positive electrode). The anode current collector 202 and the cathode current collector 210 can be made of sheets, foils (continuous or with punches or cuts), or mesh of conductive materials.

For example, the cathode current collector 210 can be made of aluminum foil, stainless steel, and/or titanium foil. Other materials are possible, such as, for example, semimetals (e.g., tin, graphite) and alloys of the metals and/or semimetals thereof. In some embodiments, the cathode current collector 210 is made of aluminum foil. The anode current collector 202 can include, for example, copper foil and/or one or more graphene layers. In some embodiments, the anode current collector 202 is made of copper foil. The thickness of a current collector can be approximately 10 to 20 μm, although other thicknesses are within the contemplated scope of this disclosure.

The anode active material layer 204 is not meant to be particularly limited, and can include, for example, lithium metal, activated carbon powder, carbon based materials such as graphite, silicon, silicon-based materials such as LiₓSi, SiOₓ, LiSiOₓ, and nano-Si, silicon-graphite composites, tin, tin oxide (SnO₂), tin-cobalt alloys, lithium titanate (Li₄Ti₅O₁₂, LTO), metal alloys such as alloys of two or more of tin, germanium, and cobalt, and combinations thereof. The anode active material layer 204 can further include electrically conductive materials such as carbon black, graphene, and/or carbon nanotubes. The anode active material layer 204 can further include a binder material such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof. The anode active material layer 204 can include, for example, greater than or equal to about 0 wt. % to less than or equal to about 20 wt. %, and in certain aspects, optionally greater than or equal to about 5 wt. % to less than or equal to about 15 wt. %, of one or more binders.

The anode active material layer 204 is not meant to be particularly limited, and can include, for example, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LMO), lithium nickel manganese oxide (LNMO), and blends and combinations thereof. In some embodiments, the cathode active material includes materials having a negative electrode capacity to positive electrode capacity ratio (also referred to as the N to P ratio) of between 1 and 3. In some embodiments, the cathode active material layer 208 can include nickel manganese cobalt (NMC) variants, such as NMC 622, NMC 811, and NMC 532. In some embodiments, the cathode active material layer 208 can include nickel and manganese at mole ratios of 30:70 to 80:20, respectively. In some embodiments, the cathode active material layer 208 can further include Co in a range between 0 and 20 percent. The cathode active material layer 208 can further include a binder material in a similar manner as described with respect to the anode active material layer 204.

Depending on battery construction (e.g., conventional vs. bi-polar current collectors, etc.) the separator 206 is optional but, if included, can be positioned to isolate the anode active material layer 204 and the cathode active material layer 208. The separator 206 also provides a minimal resistance path for internal passage of lithium ions, and in certain instances, related anions, during cycling of the lithium ions. The separator 206 can include dielectric materials such as, for example, polyethylene (PE), polypropylene (PP), polyethylene terephthalate (PET), synthetic fluoropolymer such as polytetrafluoroethylene (PTFE), and composites thereof, although other dielectrics are within the contemplated scope of this disclosure. In some embodiments, the separator 206 may include a thermally stable coating layer to improve shrinkage behavior (e.g., a porous ceramic coating or porous ester type polymer coating including, for example, polyimide, polyamide, polyimide-polyamide (PI/PA) copolymer, etc.). The thickness of the separator 206 can be approximately 12 to 16 μm, although other thicknesses are within the contemplated scope of this disclosure.

As further shown in FIG. 2, the battery cell 200 includes an electrolyte 216. The electrolyte 216 can include a liquid electrolyte, a solid electrolyte, and/or a polymer electrolyte. In some embodiments, the electrolyte 216 is a liquid electrolyte that permeates, covers, penetrates, or partially penetrates the cathode active material layer 208, the separator 206, and/or the anode active material layer 204. In some embodiments, electrolyte 216 includes a lithium salt dissolved in a solvent, although other liquid electrolytes are possible and all such configurations are within the contemplated scope of this disclosure. The lithium salt chosen in the electrolyte 216 is not meant to be particularly limited and can vary depending on the needs of a given application. In some embodiments, for example, the lithium salt includes lithium hexafluorophosphate (LiPF₆), lithium bis(trifluoromethanesulfonyl)imide (LiTFSI), lithium bis(oxalato)borate (LiBOB), lithium difluoro(oxalato)borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), and/or lithium bis(pentafluoroethanesulfonyl)imide (LiBETI), and combinations thereof.

The concentration of the lithium salt(s) in the electrolyte 216 will vary depending on the lithium salt(s) chosen and the needs of a given application. The lithium salt concentration can be varied, for example, to target a predetermined ionic conductivity (increasing the salt concentration leads to an increase in ionic conductivity up to a certain point, beyond which the conductivity may decrease due to increased ion-ion interactions and viscosity), to provide suitable levels of salt dissociation and ion mobility (for a given lithium salt, there is a minimum threshold concentration, below which the salt may not fully dissociate, leading to a lack of charge carriers; conversely, there is a maximum threshold concentration, beyond which the increased ion-ion interactions hinder ion mobility sufficiently to reduce conductivity), to provide a target electrolyte viscosity, to target a predetermined electrochemical stability window, and/or to influence the formation and composition of the SEI layer on the lithium metal anode. In some embodiments, the lithium salts can be formed to a concentration of 0.1 M to 2 M, for example, 0.8 M, although other concentrations are within the contemplated scope of this disclosure.

As will be described in greater detail below, battery cell 200 can include, incorporate, or otherwise be coupled to one or more constant force mechanisms (CFMs) to maintain a stable cell pressure as battery cell 200 expands and contracts (reversibly while charging, and irreversibly over time due to aging factors).

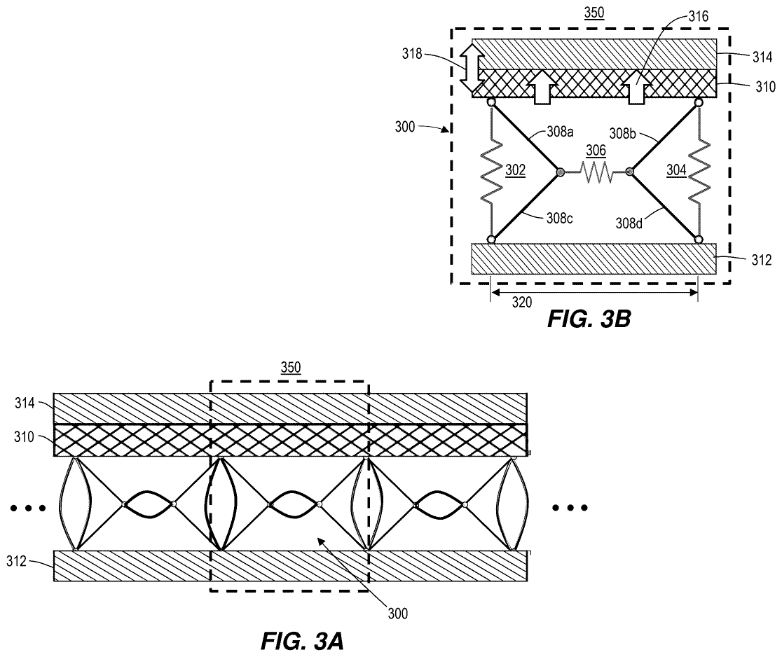

FIG. 3A depicts a plurality of constant force mechanisms 300 in accordance with one or more embodiments. FIG. 3B depicts a detailed view 350 of a constant force mechanism 300 of FIG. 3A in accordance with one or more embodiments. The number of constant force mechanisms 300 is not meant to be particularly limited, and configurations having any number of constant force mechanisms 300 are within the contemplated scope of this disclosure. As shown in FIGS. 3A and 3B, the constant force mechanism 300 includes a first biasing element (referred to herein as a first vertical spring 302), a second biasing element (referred to herein as a second vertical spring 304), a third biasing element (referred to herein as horizontal spring 306), and four rigid links 308a, 308b, 308c, and 308d (collectively, the rigid links 308). While discussed primarily in the context of helical springs for convenience, the first biasing element, second biasing element, and third biasing element can each be made, individually, of other biasing elements, such as torsion springs and bars, leaf springs, tensioners, rubber bands, magnets, hydraulic actuators, pneumatic actuators, etc.

In some embodiments, the constant force mechanism 300 is coupled to a contact plate 310 and a base plate 312. In some embodiments, contact plate 310 is coupled to a battery cell 314 (e.g., battery cell 200 of FIG. 2 and/or a battery cell of battery pack 108). In some embodiments, the first vertical spring 302 and the second vertical spring 304 connect the base plate 312 to the contact plate 310. In this configuration, contact plate 310 applies a constant force 316 to the battery cell 314, regardless of a current expansion or contraction of the battery cell 314 (that is, regardless of a current size and/or thickness of the battery cell 314).

In some embodiments, the size, positioning, and/or stiffness (e.g., spring constant) of the first vertical spring 302, the second vertical spring 304, and the horizontal spring 306 are selected to ensure that the contact plate 310 applies the constant force 316 to the battery cell 314 as battery cell 314 undergoes reversible expansion and contraction and irreversible expansion (collective referred to herein as “cell deformation 318”). More specifically, in some embodiments, vertical springs 302, 304 are designed to satisfy a pair of design criteria which, in combination with the relative positioning of the first vertical spring 302, the second vertical spring 304, the horizontal spring 306, and the four rigid links 308, ensures that the contact plate 310 applies constant force 316 to the battery cell 314 as battery cell 314 undergoes reversible and/or irreversible cell deformation 318 (also referred to as displacement dy). First, vertical springs 302, 304 are positioned such that a centerline-to-centerline distance 320 between the first vertical spring 302 and the second vertical spring 304 equals a free length (not separately indicated) of the horizontal spring 306. As used herein, a “free length” of a spring means the natural length of the spring when free of external forces/loads (that is, the rest length of the spring). Second, the first vertical spring 302 and the second vertical spring 304 have a specific spring constant that is half of a spring constant of the horizontal spring 306.

As further shown in FIG. 3B, in some embodiments, the horizontal spring 306 is positioned between the first vertical spring 302 and the second vertical spring 304. The horizontal spring 306 has a spring constant that is twice that of the vertical springs 302, 304 and a free length equal to the centerline-to-centerline distance 320 between the first vertical spring 302 and the second vertical spring 304, as described previously.

In some embodiments, first vertical spring 302, second vertical spring 304, horizontal spring 306, contact plate 310, and base plate 312 are attached or otherwise coupled using the rigid links 308. More specifically, in some embodiments, rigid link 308a (also referred to as a first rigid link) is positioned directly between a first end of the first vertical spring 302 and a first end of the horizontal spring 306 (the ends are not separately indicated). In some embodiments, rigid link 308b (also referred to as a second rigid link) is positioned directly between a first end of the second vertical spring 304 and a second end of the horizontal spring 306.

In the configuration shown in FIG. 3B, rigid link 308c (also referred to as a third rigid link) is positioned directly between a second end of the first vertical spring 302 and the first end of the horizontal spring 306. Similarly, rigid link 308d (also referred to as a fourth rigid link) is positioned directly between a second end of the second vertical spring 304 and the second end of the horizontal spring 306. Moreover, the first end of the first vertical spring 302 and the first end of the second vertical spring 304 are coupled to the contact plate 310. Conversely, the second end of the first vertical spring 302 and the second end of the second vertical spring 304 are coupled to the base plate 312.

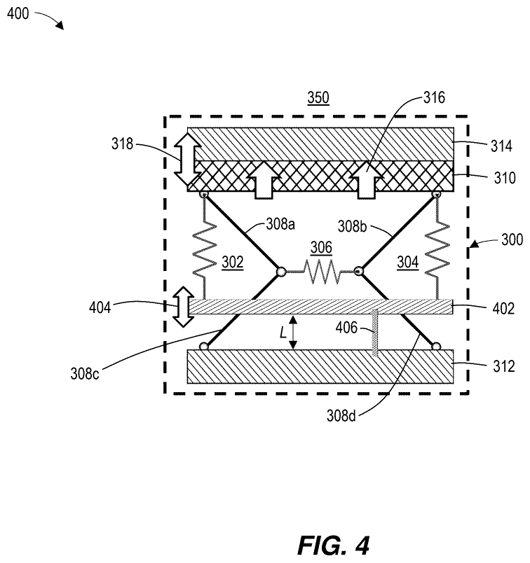

FIG. 4 depicts a detailed view of an alternative embodiment 400 of the constant force mechanism 300 of FIG. 3B in accordance with one or more embodiments. The alternative embodiment 400 is constructed in a similar manner as the constant force mechanism 300 of FIG. 3B, except that the alternative embodiment 400 includes a force adjusting plate 402. Moreover, in this configuration, the first vertical spring 302 and the second vertical spring 304 are not fixed directly to the base plate 312. Instead, the second end of the first vertical spring 302 and the second end of the second vertical spring 304 are directly coupled to the force adjusting plate 402.

In some embodiments, a position 404 (also referred to as plate delta or δ) of the force adjusting plate 402 can be adjusted to change a distance L between the force adjusting plate 402 and the base plate 312. In some embodiments, the position 404 of the force adjusting plate 402 is adjusted using an actuator 406 positioned between the force adjusting plate 402 and the base plate 312. In some embodiments, the force adjusting plate 402 is fixed via the actuator 406 such as, once position 404 is fixed, the distance L remains fixed (that is, the force adjusting plate 402 does not move freely). Advantageously, this configuration allows the force adjusting plate 402 (via adjustments to position 404) to bias the constant force 316 applied to the battery cell 314.

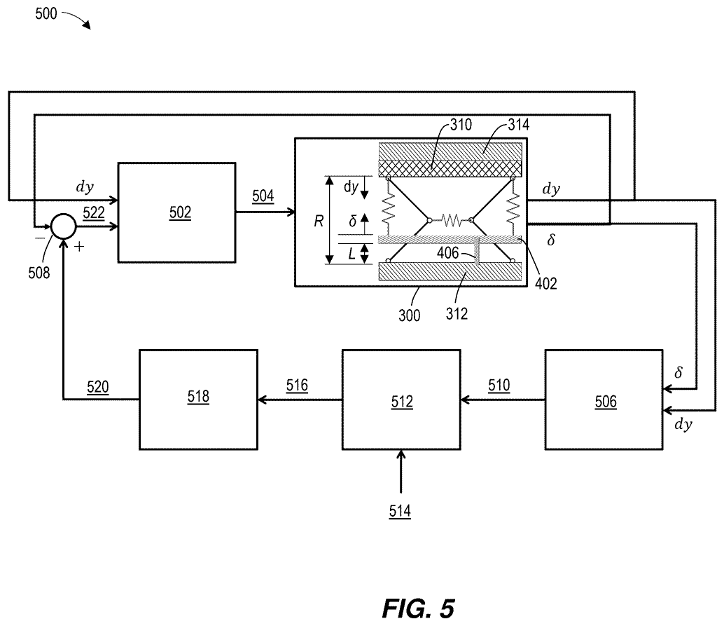

FIG. 5 depicts a control system 500 for a constant force mechanism 300 in accordance with one or more embodiments. As shown in FIG. 5, control system 500 includes a controller 502 communicatively coupled to an actuator 406 of the constant force mechanism 300. The actuator 406 is coupled to a force adjusting plate 402 as described previously with respect to FIG. 4.

In some embodiments, controller 502 sends a signal 504 to adjust a position δ (refer to position 404 of FIG. 4) of the force adjusting plate 402. Adjusting the force adjusting plate 402 in this manner changes distance L between the force adjusting plate 402 and the base plate 312. Observe that the distance R between the contact plate 310 and the base plate 312 remains fixed with respect to changes in position 404, and varies instead according to cell deformation dy (refer to cell deformation 318 of FIGS. 3B and 4).

In some embodiments, position 404 (δ) and cell deformation 318 (dy) are passed to a cell force estimator 506. In some embodiments, position 404 (δ) is also passed to an accumulator 508 (discussed in greater detail below). In some embodiments, cell deformation 318 (dy) is also returned as a feedback input to the controller 502.

In some embodiments, cell force estimator 506 generates, from the position 404 (δ) and cell deformation 318 (dy), a force estimate 510 for a current vertical force (F_{cell estimate}) experienced by the battery cell 314. In some embodiments, force estimate 510 is passed to a vertical force target estimator 512.

In some embodiments, vertical force target estimator 512 receives force estimate 510 from the cell force estimator 506 and one or more external conditions 514 from one or more upstream systems (not separately indicated). The external conditions 514 are not meant to be particularly limited, but can include, for example, ambient (atmospheric) temperature and/or pressure, state of charge (SOC) of battery cell 314, charge/discharge status and/or type (e.g., is battery cell 314 undergoing a DC fast charge, etc.). In some embodiments, vertical force target estimator 512 determines a vertical force target 516 (F_{v, target}) from the force estimate 510 and the one or more external conditions 514.

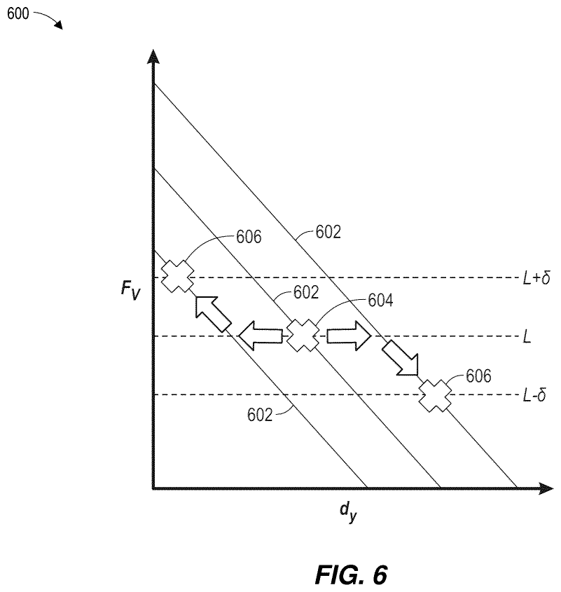

In some embodiments, vertical force target 516 is passed to a plate position estimator 518. In some embodiments, plate position estimator 518 generates, from the vertical force target 516, a target position 520 (δ_{target}). The nexus between changes in the position 404 (δ) of the force adjusting plate 402 and the vertical force (F_{cell estimate}) experienced by the battery cell 314 is discussed in greater detail with respect to FIG. 6.

In some embodiments, the target position 520 (δ_{target}) is passed to the accumulator 508. In some embodiments, accumulator 508 generates a plate adjustment 522 from the target position 520 (δ_{target}) and the position 404 (δ). In some embodiments, accumulator 508 generates a plate adjustment 522 by subtracting the (current) position 404 (δ) from the target position 520 (δ_{target}). In some embodiments, ate adjustment 522 and cell deformation 318 (dy) are passed as new input to controller 502, and the process then repeats to generate new force estimates and delta targets to maintain a constant vertical force (F_{cell estimate}) experienced by the battery cell 314.

FIG. 6 shows a graph 600 illustrating the relationship between cell force 602 and the position (δ) of a force adjusting plate (e.g., force adjusting plate 402) in accordance with one or more embodiments. Specifically, graph 600 shows two hypothetical scenarios, one where cell pressure is increasing due to cell expansion, and one where cell pressure is decreasing due to cell contraction. More specifically, graph 600 illustrates the relationship between cell force 602 and the position (δ) of a force adjusting plate (e.g., force adjusting plate 402) when using a constant force mechanism as cell pressure is releasing or increasing.

As shown in FIG. 6, a battery cell (e.g., battery cell 200, battery cell 314, etc.) begins at an initial condition 604 having an initial value for the distance L between the force adjusting plate 402 and the base plate 312 and ends at a final condition 606 having a final value for the distance L between the force adjusting plate 402 and the base plate 312 (refer to FIGS. 4 and 5). Observe that, in one scenario, as L remains constant, cell deformation 318 (dy) begins dropping. This might occur, for example, during a discharge cycle. In response, the position (δ) of a force adjusting plate can be increased (represented by L+δ) to compensate for the loss in cell deformation 318 (dy). In other words, as a battery cell contracts and begins pulling away from the constant force mechanism (refer to FIGS. 3A, 3B, 4, and 5), the position delta (δ) of the force adjusting plate can adjusted higher, thereby raising the vertical force (Fv) applied to the battery cell and thereby achieving a constant force (e.g., constant force 316) applied to the battery cell 314.

In contrast, in another scenario, as L remains constant, cell deformation 318 (dy) begins increasing. This might occur, for example, during a charge cycle. In response, the position (δ) of a force adjusting plate can be decreased (represented by L−δ) to compensate for the increase in cell deformation 318 (dy). In other words, as a battery cell expands and begins pushing into the constant force mechanism (refer to FIGS. 3A, 3B, 4, and 5), the position delta (δ) of the force adjusting plate can adjusted lower, thereby lowering the vertical force (Fv) applied to the battery cell and thereby achieving a constant force (e.g., constant force 316) applied to the battery cell 314.

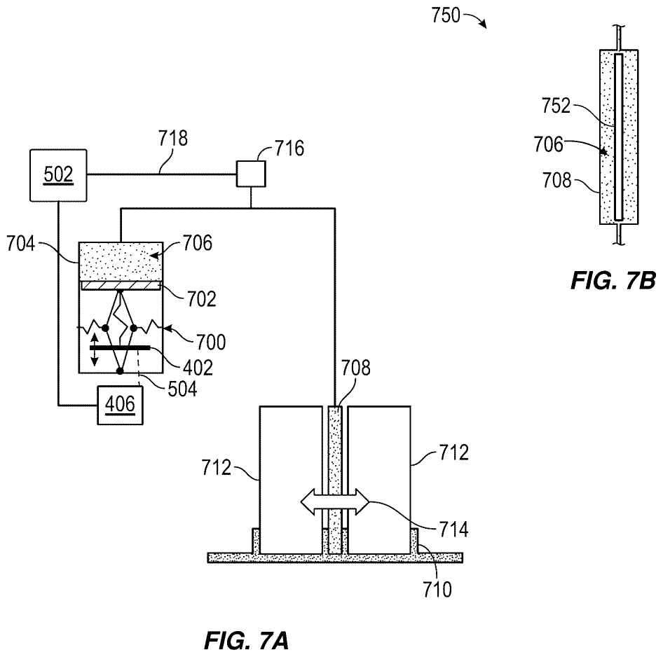

FIG. 7A depicts a constant force mechanism 700 using pressurized fluid in accordance with one or more embodiments. Constant force mechanism 700 can be formed from vertical springs, horizontal springs, and rigid links (not separately indicated) in a similar manner as described with respect to FIGS. 3A, 3B, 4, and 5, except that the constant force mechanism 700 is coupled to a piston 702 within an accumulator 704. In this configuration, piston 702 serves to push a fluid (gas or liquid, as desired) 706 into a pressurized ribbon 708. While not meant to be particularly limited, pressurized ribbon 708 can include one or more internal channels (refer to FIG. 7B) for fluid 706 and/or separate cooling fluids, and/or thermal interface materials, as desired. In some embodiments, pressurized ribbon 708 is made of an expandable material such as, for example, polyethylene (PE), polypropylene (PP), and/or thermoplastic elastomers (TPEs).

In some embodiments, constant force mechanism 700 includes a force adjusting plate 402 which can be controlled via an actuator 406 using a signal 504 generated by a controller 502 in a similar manner as described previously. In this manner, the position δ (refer to position 404 of FIG. 4) of the force adjusting plate 402 can be adjusted (increased or decreased) to bias an amount of fluid 706 forced into the pressurized ribbon 708.

In some embodiments, the pressurized ribbon 708 is placed in a tray 710 alongside one or more battery cells 712 (e.g., battery cells 200, 314, etc.). The tray 710 serves to fix (also referred to as locate) the relative positions of the pressurized ribbon 708 and various battery cells. Observe that, as the battery cells 712 expand and contract, the respective battery cells 712 will push into, or retreat from, the pressurized ribbon 708. Thus, adjusting the position 404 (δ) of the force adjusting plate 402 (increasing or decreasing, as needed) can bias an amount of fluid 706 forced into the pressurized ribbon 708, thereby allowing a force 714 applied by the pressurized ribbon 708 against the respective battery cells 712 to remain constant. In some embodiments, a pressure sensor is placed to take periodic, continuous, and/or intermittent (as desired for a given application) pressure readings 718 of the fluid 706. In some embodiments, the pressure readings 718 are passed to the controller 502 (refer to FIG. 5).

FIG. 7B depicts a detailed view 750 of the pressurized ribbon 708 of FIG. 7A in accordance with one or more embodiments. In some embodiments, pressurized ribbon 708 includes a thermal barrier 752. In some embodiments, the fluid 706 is a cooling fluid in addition to a working fluid for maintaining constant compression forces in the pressurized ribbon 708. Advantageously, this configuration can eliminate the need for a thermal interface material (TIM) between adjacent battery cells 712. Moreover, this configuration simplifies manufacturing and assembly by eliminating the need for cell compression at the module/pack level. Other advantages are possible.

In some embodiments, the force adjusting plate 402 can be moved (delta can be increased or decreased) to change an amount of fluid 706 forced into pressurized ribbon 708 during a detected thermal event in any of the battery cells 712. More specifically, cell pressure can be reduced during a thermal event by adjusting a position 404 of the force adjusting plate 402 to increase thermal resistance between the battery cells 712 (e.g., to minimize boiling, etc.).

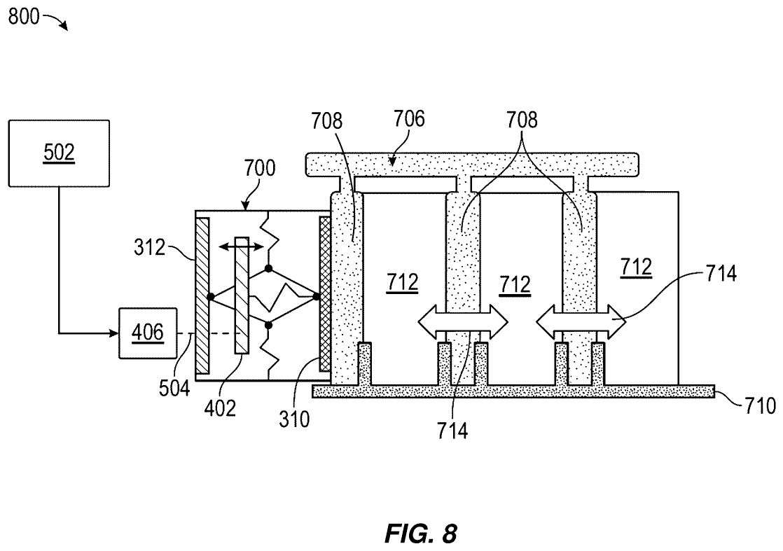

FIG. 8 depicts an alternative embodiment 800 of a constant force mechanism 700 using pressurized fluid in accordance with one or more embodiments. The embodiment 800 shown in FIG. 8 includes the constant force mechanism 700 having vertical springs, horizontal springs, and rigid links (not separately indicated) configured in a similar manner as described with respect to FIG. 7, except that the piston 702 is replaced with a contact plate 310 (refer to FIG. 3) positioned directly against at least one pressurized ribbon 708.

In this configuration, contact plate 310 serves to push a fluid 706 into the one or more pressurized ribbons 708 (as shown, three pressurized ribbons 708). The number of pressurized ribbons 708 shown is merely illustrative and any number of pressurized ribbons 708 can be coupled as needed and all such configurations are within the contemplated scope of this disclosure. In some embodiments, each of the one or more pressurized ribbons 708 is made of an expandable material such as, for example, polyethylene (PE), polypropylene (PP), and/or thermoplastic elastomers (TPEs).

In some embodiments, constant force mechanism 700 includes a force adjusting plate 402 which can be controlled via an actuator 406 using a signal 504 generated by a controller 502 in a similar manner as described previously. In this manner, the position 404 (δ) of the force adjusting plate 402 can be adjusted (increased or decreased) to bias an amount of fluid 706 forced into the one or more pressurized ribbons 708.

In some embodiments, the pressurized ribbons 708 are placed in a tray 710 alongside one or more battery cells 712 (e.g., battery cells 200, 314, etc.). The tray 710 serves to fix (also referred to as locate) the relative positions of the pressurized ribbons 708 and the various battery cells. Observe that, as the battery cells 712 expand and contract, the respective battery cells 712 will push into, or retreat from, the pressurized ribbons 708. Thus, adjusting the position 404 (δ) of the force adjusting plate 402 (increasing or decreasing, as needed) can bias an amount of fluid 706 forced into the pressurized ribbon 708, thereby allowing a force 714 applied by the respective pressurized ribbons 708 against the respective battery cells 712 to remain constant.

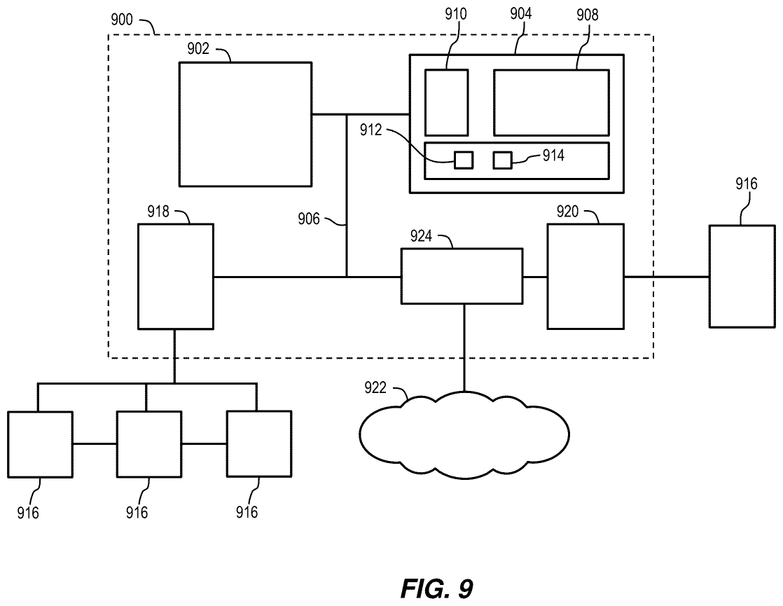

FIG. 9 illustrates aspects of an embodiment of a computer system 900 that can perform various aspects of embodiments described herein. In some embodiments, the computer system(s) 900 can implement and/or otherwise be incorporated within or in combination with a constant force mechanism or a system(s) supporting a constant force mechanism, such as, for example, the actuator 406, controller 502, plate position estimator 518, vertical force target estimator 512, and cell force estimator 506 of FIG. 5. For example, in some embodiments, computer system 900 can determine a desired vertical force and a corresponding position 404 for a force adjusting plate 402, and/or can send a signal 504 to control actuator 406 to physically move the force adjusting plate 402.

The computer system 900 includes at least one processing device 902, which generally includes one or more processors or processing units for performing a variety of functions, such as, for example, any and/or all of the functions previously described. Components of the computer system 900 also include a system memory 904, and a bus 906 that couples various system components including the system memory 904 to the processing device 902. The system memory 904 may include a variety of computer system readable media. Such media can be any available media that is accessible by the processing device 902, and includes both volatile and non-volatile media, and removable and non-removable media. For example, the system memory 904 includes a non-volatile memory 908 such as a hard drive, and may also include a volatile memory 910, such as random access memory (RAM) and/or cache memory. The computer system 900 can further include other removable/non-removable, volatile/non-volatile computer system storage media.

The system memory 904 can include at least one program product having a set (e.g., at least one) of program modules that are configured to carry out functions of the embodiments described herein. For example, the system memory 904 stores various program modules that generally carry out the functions and/or methodologies of embodiments described herein. A module or modules 912, 914 may be included to perform functions related to any of the block diagrams described herein. The computer system 900 is not so limited, as other modules may be included depending on the desired functionality of the computer system 900. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 902 can also be configured to communicate with one or more external devices 916 such as, for example, a keyboard, a pointing device, and/or any devices (e.g., a network card, a modem, etc.) that enable the processing device 902 to communicate with one or more other computing devices. Communication with various devices can occur via Input/Output (I/O) interfaces 918 and 920.

The processing device 902 may also communicate with one or more networks 922 such as a local area network (LAN), a general wide area network (WAN), a bus network and/or a public network (e.g., the Internet) via a network adapter 924. In some embodiments, the network adapter 924 is or includes an optical network adaptor for communication over an optical network. It should be understood that although not shown, other hardware and/or software components may be used in conjunction with the computer system 900. Examples include, but are not limited to, microcode, device drivers, redundant processing units, external disk drive arrays, RAID systems, and data archival storage systems, etc.

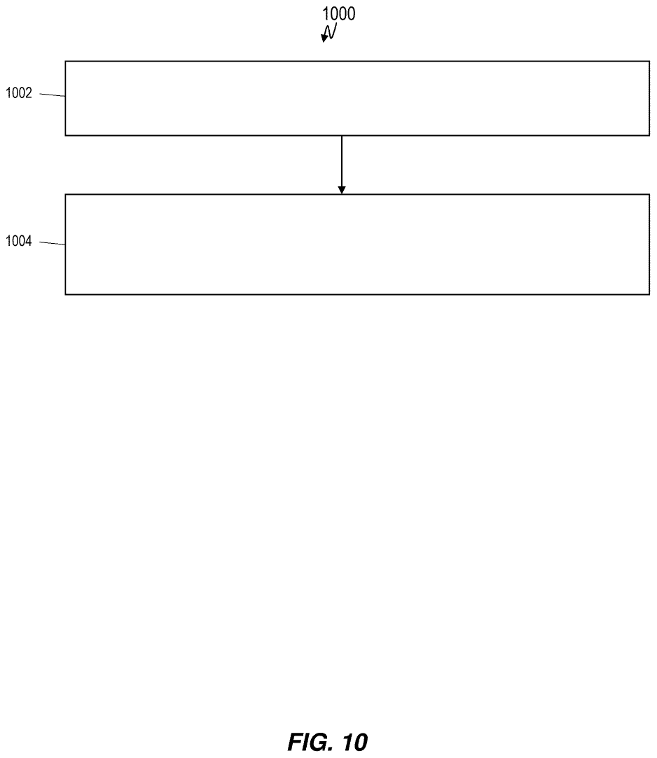

Referring now to FIG. 10, a flowchart 1000 for leveraging a constant force mechanism is generally shown according to an embodiment. The flowchart 1000 is described in reference to FIGS. 1-9 and may include additional steps not depicted in FIG. 10. Although depicted in a particular order, the blocks depicted in FIG. 10 can be rearranged, subdivided, and/or combined.

At block 1002, the method includes providing a battery pack having a plurality of battery cells.

At block 1004, the method includes coupling a constant force mechanism to at least one battery cell of the plurality of battery cells. In some embodiments, the constant force mechanism includes a first vertical spring, a second vertical spring, a horizontal spring, and a plurality of rigid links. In some embodiments, a centerline-to-centerline distance between the first vertical spring and the second vertical spring is equal to a free length of the horizontal spring. In some embodiments, a first spring constant of the first vertical spring and a second spring constant of the second vertical spring are the same, and the first spring constant and the second spring constant are each half a third spring constant of the horizontal spring.

In some embodiments, the method includes forming a piston coupled to the constant force mechanism and forming a ribbon positioned adjacent to the at least one battery cell. In some embodiments, displacing the piston adjusts a volume of fluid in the ribbon.

In some embodiments, the method includes forming a force adjusting plate and coupling an actuator to the force adjusting plate. The actuator is configured to change a distance between the force adjusting plate and the piston.

In some embodiments, the method includes providing a pressure sensor to monitor a pressure of the fluid and coupling a controller to the actuator. The controller is configured to direct the actuator to change the distance between the force adjusting plate and the piston responsive to a measurement of the pressure sensor.

In some embodiments, the method includes forming a battery cell tray coupled to each battery cell of the plurality of battery cells. The battery cell tray is configured to prevent cell-to-cell relative motion between the battery cells of the plurality of battery cells.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C. ” Unless explicitly stated otherwise in connection with a particular instance in this disclosure, this manner of phrasing does not mean “at least one of A, at least one of B, and at least one of C. ” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor;
a battery pack electrically coupled to the electric motor, the battery pack comprising a plurality of battery cells; and
a constant force mechanism coupled to at least one battery cell of the plurality of battery cells, the constant force mechanism comprising:
a first vertical spring;
a second vertical spring;
a horizontal spring; and
a plurality of rigid links;
wherein a centerline-to-centerline distance between the first vertical spring and the second vertical spring is equal to a free length of the horizontal spring, the free length comprising a length of the horizontal spring when free of an external load; and
wherein a first spring constant of the first vertical spring and a second spring constant of the second vertical spring are the same, and the first spring constant and the second spring constant are each half a third spring constant of the horizontal spring.

2. The vehicle of claim 1, wherein the plurality of rigid links comprises:
a first rigid link coupled to a first end of the first vertical spring and a first end of the horizontal spring; and
a second rigid link coupled to a first end of the second vertical spring and a second end of the horizontal spring.

3. The vehicle of claim 2, wherein the plurality of rigid links comprises:
a third rigid link coupled to a second end of the first vertical spring and the first end of the horizontal spring; and
a fourth rigid link coupled to a second end of the second vertical spring and the second end of the horizontal spring.

4. The vehicle of claim 3, further comprising:
a contact plate in direct contact with a first battery cell of the plurality of battery cells;
wherein the first end of the first vertical spring and the first end of the second vertical spring are coupled to the contact plate.

5. The vehicle of claim 4, further comprising:
a base plate;
wherein the second end of the first vertical spring and the second end of the second vertical spring are coupled to the base plate.

6. The vehicle of claim 2, wherein the plurality of rigid links comprises:
a third rigid link coupled to the first end of the horizontal spring; and
a fourth rigid link coupled to the second end of the horizontal spring.

7. The vehicle of claim 6, further comprising:
a contact plate in direct contact with a first battery cell of the plurality of battery cells; and
a base plate coupled to the third rigid link and the fourth rigid link.

8. The vehicle of claim 7, further comprising a force adjusting plate;
wherein a second end of the first vertical spring and a second end of the second vertical spring are coupled to the force adjusting plate.

9. The vehicle of claim 8, further comprising an actuator coupled to the force adjusting plate, the actuator configured to change a distance between the force adjusting plate and the first battery cell.

10. The vehicle of claim 9, further comprising a controller coupled to the actuator, the controller configured to direct the actuator to change the distance between the force adjusting plate and the first battery cell to adjust an amount of force applied against the first battery cell.

11. A system comprising:
a battery pack comprising a plurality of battery cells; and
a constant force mechanism coupled to at least one battery cell of the plurality of battery cells, the constant force mechanism comprising:
a first vertical spring;
a second vertical spring;
a horizontal spring; and
a plurality of rigid links;
wherein a centerline-to-centerline distance between the first vertical spring and the second vertical spring is equal to a free length of the horizontal spring, the free length comprising a length of the horizontal spring when free of an external load; and
wherein a first spring constant of the first vertical spring and a second spring constant of the second vertical spring are the same, and the first spring constant and the second spring constant are each half a third spring constant of the horizontal spring.

12. The system of claim 11, further comprising:
a piston coupled to the constant force mechanism; and
a ribbon positioned adjacent to the at least one battery cell;
wherein displacing the piston adjusts a volume of fluid in the ribbon.

13. The system of claim 12, wherein the system further comprises:
a force adjusting plate; and
an actuator coupled to the force adjusting plate, the actuator configured to change a distance between the force adjusting plate and the piston.

14. The system of claim 13, wherein the system further comprises:
a pressure sensor; and
a controller coupled to the actuator, the controller configured to direct the actuator to change the distance between the force adjusting plate and the piston responsive to a measurement of the pressure sensor.

15. The system of claim 14, wherein the system further comprises a battery cell tray coupled to each battery cell of the plurality of battery cells, the battery cell tray configured to prevent cell-to-cell relative motion between the battery cells of the plurality of battery cells.

16. A method comprising:
providing a battery pack comprising a plurality of battery cells; and
coupling a constant force mechanism to at least one battery cell of the plurality of battery cells, the constant force mechanism comprising:
a first vertical spring;
a second vertical spring;
a horizontal spring; and
a plurality of rigid links;
wherein a centerline-to-centerline distance between the first vertical spring and the second vertical spring is equal to a free length of the horizontal spring, the free length comprising a length of the horizontal spring when free of an external load; and
wherein a first spring constant of the first vertical spring and a second spring constant of the second vertical spring are the same, and the first spring constant and the second spring constant are each half a third spring constant of the horizontal spring.

17. The method of claim 16, further comprising:
forming a piston coupled to the constant force mechanism; and
forming a ribbon positioned adjacent to the at least one battery cell;
wherein displacing the piston adjusts a volume of fluid in the ribbon.

18. The method of claim 17, further comprising:
forming a force adjusting plate; and
coupling an actuator to the force adjusting plate, the actuator configured to change a distance between the force adjusting plate and the piston.

19. The method of claim 18, further comprising:
providing a pressure sensor to monitor a pressure of the fluid; and
coupling a controller to the actuator, the controller configured to direct the actuator to change the distance between the force adjusting plate and the piston responsive to a measurement of the pressure sensor.

20. The method of claim 19, further comprising forming a battery cell tray coupled to each battery cell of the plurality of battery cells, the battery cell tray configured to prevent cell-to-cell relative motion between the battery cells of the plurality of battery cells.
